(19) United States
(12) Patent Application Publication
(10) Pub. No.: US 2025/0065289 A1
(43) Pub. Date: Feb. 27, 2025

(54) DEVICE FOR ANALYSING ELECTROCATALYTIC REACTIONS

(71) Applicant: HTE GMBH THE HIGH THROUGHPUT EXPERIMENTATION COMPANY, Heidelberg (DE)

(72) Inventors: Stefan Guenter Resch, Grossbettlingen (DE); Andreas Mueller, Heidelberg (DE); Stephan Schunk, Heidelberg (DE); Fabian Schneider, Heidelberg (DE); Michael Dejmek, Heidelberg (DE); Ralf Kuppinger, Heidelberg (DE); Oliver Koechel, Heidelberg (DE)

(21) Appl. No.: 18/724,751

(22) PCT Filed: Jan. 4, 2023
(86) PCT No.: PCT/EP2023/050110

§ 371 Date: Jun. 27, 2024

(30) Foreign Application Priority Data
Jan. 5, 2022 (EP) 22150324.6

(51) Int. Cl. B01J 19/08; B01J 19/00

(52) U.S. Cl. CPC B01J 19/087; B01J 19/0066; B01J 2219/00763; B01J 2219/0809; B01J 2219/0824; B01J 2219/0892

(57) ABSTRACT

The invention relates to an apparatus for investigating electrocatalytic reactions comprising a container (3) having a stirrer (5), wherein the container (3) is internally lined with an electrically insulating coating or is manufactured from an electrically insulating material and the stirrer (5) has at least one stirrer shaft (17) provided with an electrically insulating coating or manufactured from an electrically insulating material and electrodes (9, 9a, 9b; 11, 11a, 11b) configured as exchangeable baskets (7; 7a; 7b) are positioned in the container (3).

The invention relates to an apparatus for investigating electrocatalytic reactions in the liquid phase comprising a container having a stirrer as the reaction vessel.

To investigate chemical reactions it is known from process engineering to employ standardized reactor types such as flow tubes or stirred tanks initially on a laboratory scale and to scale up the understanding obtained therefrom to pilot plants or large industrial scale plants (upscaling). Conventional energy transfer processes are generally limited to heating the media and not to direct energetic conversion into more energy-rich chemical products. Direct energetic conversion requires new designs that must be directed to providing comparable and also upscalable types. An example of an energetic conversion into more energy-rich chemical products is the conversion of carbon dioxide in the supercritical state into commodity products for intermediate energy storage such as oxalic acid, formic acid or formaldehyde when, for example, load peaks from wind energy or solar cells are to be managed. As soon as gases are involved in the reaction it is advantageous to perform the process at a high mass or mass flow loading at high pressure in autoclaves suitable therefor. Single-phase process states which provide ideal mass transfer conditions are particularly suitable.

For heterogeneously catalyzed reactions it is known to immobilize the catalyst in baskets for example. The baskets may either have a stationary position in the reactor or be in a dynamic arrangement. Stationary installations of the baskets are realized, for example, in a Berty reactor, a Robinson-Mahoney reactor or a Caldwell reactor. These contrast with Carberry reactors where the catalyst basket is connected to a rotating shaft so that the catalyst baskets rotate in the reaction vessel.

Electrocatalysts facilitate or enable chemical reactions analogously to heterogeneous catalysts. In addition to surface-active processes on catalysts, which reduce activation energy for a chemical reaction, electrocatalysts can additionally reduce activation energy by applying an electrical potential. It is thus possible in principle also to implement electrocatalytically any chemical reactions for which a suitable electrolyte can be found. Examples where this is the case include electrolytic processes, for example chloralkali electrolysis, water electrolysis, fuel cells, metal deposition by reduction of metal salts, batteries, electrodialysis, electroplating methods, organic syntheses such as the dimerization of acrylonitrile to adiponitrile, Kolbe electrolysis, inorganic syntheses and also photoelectrochemical processes, for example in a photogeneration cell or Grätzel cell. Operating modes can be potentiostatic or galvanostatic.

US-A 2016/0256847 describes a centrifugal reactor having a rotor with radially oriented blades that form radial chambers. A catalyst used for the reaction is accommodated in the radial chambers. Alternatively, the rotor may also be an annular brush made of a fibrous catalyst. To apply an electric field the rotor comprises two disks that are electrically contacted.

DE-U 20 2020 107 313 discloses an apparatus for investigating chemical processes which comprises a stacked plate reactor comprising a plurality of adjacent plate-shaped subunits. These each have an inflow and outflow and the individual plates may be alternately connected as anodes and as cathodes in order to apply an electric field.

A disadvantage of reactors known from the prior art for investigating chemical processes is that these are in each case continuously operated in such a way that the reactants are continuously supplied, a reaction mixture is formed in the reactor through at least partial conversion of the reactants into a product, and the reaction mixture is then continuously withdrawn from the reactor. However, such reactors cannot be used to investigate reactions performed in stirred tank reactors. In particular, reactions with longer residence times which are typically performed in a batch process cannot be replicated with the known reactors.

Especially for investigating electrocatalytic reactions in batch reactors, especially stirred tank reactors, it is necessary to introduce electrodes in such a way that uniform contact of the components in the reactor with the electrodes is ensured. Batch reactors typically have a reactor vessel which is a three-dimensional body that complicates two-dimensional contacting of the media present therein with the generally two-dimensional electrodes. Upscaling of the results obtained with such a reactor to a pilot plant or a large-scale plant for production moreover requires the establishment of reproducible parameters such as the actually utilized electrode area, establishment of precisely parallel electrode spacings and defined flow formation on the surface of the electrodes.

Since investigation of reactions also necessitates rapid exchange of components or plant component parts, in particular of electrodes, good accessibility and easy exchange without subsequently necessary recalibration or orientation of the parts is desirable.

It is accordingly an object of the present invention to provide an apparatus for investigating electrocatalytic reactions performed in batch reactors which does not have the disadvantages known from the prior art.

This object is achieved by an apparatus for investigating electrocatalytic reactions comprising a container having a stirrer as the reaction vessel, wherein the container is internally lined with an electrically insulating coating or is manufactured from an electrically insulating material and the stirrer has at least one stirrer shaft provided with an electrically insulating coating or manufactured from an electrically insulating material and electrodes configured as exchangeable baskets are positioned in the container.

The use of electrodes configured as exchangeable baskets in the reaction vessel makes it possible to ensure a defined contact of the medium present in the reactor with the electrode. In this way reproducible investigations may be performed and possible upscaling to pilot plants or large industrial scale production plants is facilitated. The exchangeability of the baskets also allows easy exchange to allow investigation, for example in screening investigations, of different electrode materials or else different catalysts which are preferably accommodated in the basket. The electrodes configured as exchangeable baskets also allow simplified investigation of reactions in which a sacrificial electrode is consumed during the reaction, since simple exchange is possible when the electrode has been consumed up to a certain proportion.

The electrodes employed in the apparatus and forming the basket may be macroporous, microporous or else nonporous. If the electrodes are macroporous they are preferably in the form of a weave or braid or else a felt or nonwoven. It is also possible to form the electrodes as a metal sheet having a multiplicity of openings or in the form of a foam. If the electrodes are in the form of a foam it is particularly preferable when the foam is open-celled so that the medium obtained in the reactor can flow through the electrode and a large electrode surface area is simultaneously provided. However, it is particularly preferable when the electrodes are in the form of a weave, braid, felt or nonwoven, in particular in the form of a weave or braid. Especially the use of open-celled foam for the electrodes can improve the mass-transfer coefficient and the heat-transfer coefficient.

Typical microporous electrodes include for example electrodes such as are presently used as gas diffusion electrodes or oxygen depolarized electrodes. Such electrodes are generally microporous membranes or sintered electrodes.

Nonporous electrodes include any electrodes having a gas- and/or liquid-impermeable surface so that the reaction medium present in the reaction vessel flows over the surface of the electrode but cannot penetrate or flow through said electrode.

In order to generate an electric field it is necessary to employ at least one positive electrode and at least one negative electrode in the reaction vessel since due to the coating with the electrically insulating material or the manufacture from the electrically insulating material neither the container nor the stirrer shaft can function as an electrode.

In order to obtain homogeneous residence times of the reaction medium at the electrodes and also to allow easy exchange and use of the electrodes and in particular to obtain reproducible results and precise and reproducible positioning of the electrodes relative to one another it is preferable when in each case a positive and a negative electrode are joined to form a basket via electrically non-conductive joins. This makes it possible to prepare the electrodes outside the reaction vessel and to produce baskets having identical dimensions before these are placed in the reaction vessel. This eliminates the need for calibration of the electrodes to one another in the reaction vessel. In addition the electrodes are also much easier to position relative to one another outside the reaction vessel since they are more easily accessible than electrodes that have already been installed in the reaction vessel.

The interspace between the negative and the positive electrode, i.e. the interior of the basket, may be empty or filled. When the interior of the basket is filled it may contain flow-conducting and/or heat-dissipating elements for example. The interior of the basket may moreover also be filled with a membrane, a membrane having a support structure or a support structure for the basket or with a catalytically active material. The catalytically active material may simultaneously also be flow-conducting.

Flow-conducting elements, which may be accommodated in the interior of the basket, include for example turbulence promoters or random packings, wherein the random packings may be inert or catalytically active.

In addition to catalytically active random packings the catalytically active material may also be introduced into the basket in the form of a granulate or as a structured packing.

Suitable heat-dissipating elements include all materials having good thermal conductivity. These may likewise be introduced into the basket in the form of turbulence promoters or random packings. To allow the heat to be removed from the reactor vessel using the heat-dissipating elements it is necessary to provide suitable thermal conductors which remove the heat through the wall of the reactor vessel or preferably through the lid of the reactor vessel. Suitable thermal conductors include for example heat pipes which are contacted on one side with the heat-dissipating elements and on the other side emit the heat to the environment or to a temperature control medium.

In addition to the use of heat-dissipating elements made of materials having good thermal conductivity it is also possible to arrange channels traversed by a temperature control medium in the interior of the basket. In this case the heat formed in an exothermic reaction for example is emitted to the temperature control medium which transports it outwards from the reactor vessel. If it is necessary to supply additional heat it is alternatively also possible to pass a correspondingly hot temperature control medium into the traversed channels.

If a membrane is present in the basket it is particularly preferably ion-conducting and functions as a solid electrolyte. The membrane may be inert towards the media in the reactor. It is alternatively also possible for the membrane to be catalytically active. In this case it is possible for example to manufacture the membrane from a catalytically active material or, preferably, to coat it with a catalytically active material or to introduce catalytically active material especially into the pores of the membrane. Especially at a distance of the electrodes forming the basket that is greater than the membrane thickness it is further preferable to provide a support structure to stably retain the membrane at its position in the basket.

It is moreover also possible for the baskets to be each configured as double-walled electrodes, wherein a separating membrane is accommodated between the electrodes. In this case it is particularly preferable when one of the double-walled electrodes is a negative electrode and one of the double-walled electrodes is a positive electrode. The separating membrane electrically insulates the electrodes from one another so that these are not in direct electrical contact. As an alternative to a connection such that an electrode of the double-walled electrodes is a positive electrode and the other electrode is a negative electrode it is also possible for both electrodes to be positive electrodes or both electrodes to be negative electrodes. In this case it is necessary to provide a second basket comprising at least one electrode which is of opposite polarity, i.e. is negative in the case of two positive electrodes and is negative in the case of two positive electrodes. However, it is particularly preferable when in the case of the baskets configured as double-walled electrodes one electrode of the double-walled electrodes is negative and the other electrode is positive. The separating membrane which is accommodated between the electrodes may be manufactured from any desired material known to those skilled in the art which is electrically insulating or functions as a solid electrolyte. When the membrane functions as a solid electrolyte it is particularly preferable when the membrane is ion-conducting to transport ions from the liquid in the reaction vessel from one electrode through the membrane to the other electrode and thus promote the chemical reaction at the electrode.

The electrodes may be positioned in the reaction vessel in different ways.

In one embodiment the electrodes are arranged perpendicularly to a central shaft through the reactor or radially encompass the central shaft of the reactor. The electrodes configured as baskets are not joined to the rotor shaft and are therefore immovably positioned in the reactor vessel. If the electrodes configured as baskets are arranged perpendicularly to a central shaft through the reactor the arrangement corresponds to that of a Berty reactor for example. To transport the reaction medium through the electrodes configured as baskets a stirrer is preferably arranged above or below the basket. This is particularly preferably an axially conveying stirrer. In this way the reaction medium is conveyed through the basket formed by the electrodes and is uniformly contacted with the electrodes. A further advantage resulting from the use of the stirrer is that gas bubbles formed at the electrodes especially during reactions in the liquid phase which would otherwise reduce conversion through surface coverage on the electrodes and which generally comprise a gaseous reaction product are carried away from the electrodes by the flow induced by the stirrer and can ascend in the vessel in the direction of a gas phase above the liquid phase.

If the electrode configured as a basket radially encompasses the central shaft of the reactor the basket preferably has a cylindrical shape and the cylinder wall is formed from the electrodes. It is particularly preferable when the positive electrode and the negative electrode form two concentric cylindrical sleeves that are joined to one another. The construction may be similar to that of a Robinson-Mahoney reactor for example. The stirrer is preferably arranged within the basket formed by the electrodes. It is alternatively also possible to arrange a stirrer above the basket and a stirrer below the basket. If only one stirrer is used it is preferable to employ an axially conveying stirrer to transport the reaction medium through the basket. When two stirrers are employed these are preferably arranged to form a radial flow, so that the liquid reaction medium flows through the basket formed by the electrodes. The advantage of the electrodes radially encompassing the central shaft of the reactor is that this generates a more homogeneous flow profile and thus also a correspondingly more homogeneous residence time per unit area. This facilitates upscaling to pilot plants or large-scale plants for industrial production. Another advantage is that the established laminar boundary layer on the surface of the electrodes has a constant thickness and thus constant mass transfer numbers. This is particularly important for thin film electrodes.

In contrast to the electrodes radially encompassing the central shaft of the reactor the flow profile through electrodes perpendicular to the central shaft of the reactor is generally nonlinear. It is therefore preferable to employ electrodes which radially encompass the central shaft of the reactor.

In addition to the use of static and thus immovable electrodes it is alternatively also possible to employ dynamic electrodes. In this case the electrodes configured as baskets are especially joined to the stirrer shaft. The electrodes configured as baskets thus rotate in the reactor vessel, wherein the rotation of the electrodes configured as baskets also generates a flow in the reaction medium so that the electrodes joined to the stirrer shaft simultaneously function as stirrer blades. The electrodes configured as baskets may be arranged at any desired angle to the stirrer shaft, wherein a configuration such as for example in a Carberry reactor, where the electrodes joined to the stirrer shaft are arranged parallel to the stirrer shaft, is preferred.

Alternatively to an arrangement of the electrodes configured as baskets such that the individual baskets are arranged parallel to the stirrer shaft, it is also possible to arrange the electrodes configured as baskets perpendicularly to the stirrer shaft. For good contact of the reaction medium with the electrodes it is in this case further preferable when stirrer blades of a radial rotor are arranged between the electrodes arranged perpendicularly to the stirrer shaft. The stirrer blades of the radial rotor transport the medium radially outwards and thus bring it into contact with the surface of the electrodes arranged perpendicularly to the rotor shaft.

In contrast to static electrodes which are suitable especially when upscaling is the focus, dynamic electrodes are suitable when intrinsic kinetics are to be investigated without mass transfer limitations.

In addition to the above-described arrangements with static or dynamic electrodes it is further also possible to operate one electrode statically and one electrode dynamically. Such an arrangement results in a rotor/stator principle as is implemented for heterogeneously catalyzed reactions in a Caldwell reactor for example. On the rotating electrode the layer of the electrolyte close to the wall is exchanged particularly rapidly to reduce concentration gradients. Electrolyte applied in proximity to the shaft flows outward more or less rapidly depending on the speed of rotation. The resulting liquid film has a precisely defined film thickness that is established as a result. To this end it is possible for example to make the stirrer shaft to which the dynamic electrodes are secured hollow, so that the electrolyte flows through the hollow stirrer shaft through an opening onto the disc-shaped electrode. To this end the electrolyte is preferably aspirated into the hollow stirrer shaft from the lower region of the reaction vessel in which it collects once it has been scattered by the rotating electrode. An alternating arrangement of a plurality of stationary and dynamic electrodes one atop another makes it possible to correspondingly increase the wetted area. Structuring the surface that influences the flow of the electrolyte, for example by superposing an axial flow on the radial flow imposed by the rotation, makes it possible for the mass transfer to be intensified and increased on account of the longer residence time on the electrode.

It is necessary in electrocatalyzed reactions that either a liquid electrolyte is present in the reaction medium or alternatively a solid electrolyte is arranged between the positive electrode and the negative electrode and contacts both electrodes. The ion stream is conducted from the negative electrode to the positive electrode through the liquid electrolyte or the solid electrolyte. If the reaction medium comprises a liquid electrolyte this may either be a reactant or product of the chemical reaction to be investigated or be inert towards the components involved in the reaction. When using a solid electrolyte the reaction mixture may be selected independently of the electrolyte.

When using a liquid electrolyte one of the two electrodes or alternatively both electrodes may be configured as gas diffusion electrodes. A reaction gas is passed through a porous layer through the electrode to react either at the electrode or in the liquid electrolyte. It is alternatively also possible to discharge product gases through such a gas diffusion layer at one of the two electrodes.

The employed electrodes generally comprise a current collector composed of a metal or of graphite, a substrate as the carrier for the electrocatalyst and, if employed, the catalytically active material and a contact material between the catalyst and the current-conducting layer. Suitable metals for the current collector include for example copper, aluminum, titanium or stainless steel. Suitable substrates especially include metallic fabrics or carbon fabrics, wherein the metals suitable here are the same as for the current collector. Employable contact materials between the catalyst and the current-conducting layer include for example carbon, for example graphite, or conductive polymers.

The employed electrolyte ensures ionic conductivity. When solid electrolytes are employed these may be for example anionic or cationic polymer membranes, for example Nafion®, or ionically conductive ceramics, for example yttrium-stabilized zirconium oxide.

Suitable liquid electrolytes not involved in the reaction include inter alia metal salt solutions, salt melts or ionic liquids. Since when a liquid electrolyte is employed the chemical reaction occurs in the electrolyte, said electrolyte should have a high vapor pressure at elevated temperatures and ensure good dissipation of the reaction heat. It is also advantageous when the electrolyte has a low viscosity.

When a liquid electrolyte is employed and said electrolyte is not part of the reaction mixture but rather is inert towards the chemical reaction it is moreover generally necessary for it to be separable from the reaction mixture. Depending on the employed electrolyte this may be effected for example via a phase change through addition of a solvent for example or through alteration of the process conditions which alter the solubility of the components involved in the reaction in the electrolyte, for example alteration of temperature or pressure. If an electrolyte that is insoluble in the reaction mixture is used, thus forming an emulsion of reaction mixture and electrolyte, it is also possible to connect a phase separator, in which the electrolyte is separated from the reaction mixture, downstream of the reaction vessel. If the electrolyte is insoluble in the reaction mixture then the former is preferably the continuous phase of the emulsion in order that ion transport and thus external current flow can be ensured.

If the electrodes configured as baskets are filled with a solid, for example a catalytically active material or a turbulence promoter, it is simultaneously also possible for the solid to be electrically or ionically conductive and in the former case to function as an electrocatalyst and in the latter case to function as a solid electrolyte. In this case the electrical potential is transferred from particle to particle in the solid through electrical or ionic conduction. If the particles are not packed so tightly that they are immovably accommodated in the basket but rather particle motion in the basket may be established, charge transfer from particle to particle can also occur. Two orientation directions can in any case be distinguished. This allows the potential and flow direction of the media to be parallel or perpendicular to one other. This allows the achievable limiting current densities to be increased by up to a factor of 100 when filling the electrode interspace.

If multi-phase reactions are to be performed, in particular those where at least one reactant and/or the product is gaseous, and at least one component, for example a reactant, the electrolyte or the product is liquid, it is preferable to employ gas diffusion electrodes. To this end the porous electrodes have an internal distribution system for introducing or discharging gases into the electrode. It is particularly preferable when the gas diffusion electrodes are positioned at the phase interface between a gas space at the top of the reactor and the liquid in the reactor vessel. However, it is alternatively also possible for the gas diffusion electrodes to have a dedicated gas feed and be completely immersed in the liquid.

The electrodes configured as baskets may be used as a potential means for reducing activation energy or alternatively also themselves be coated with a catalytically active material or be manufactured from a catalytically active, electrically conductive material. Electrodes coated with a catalytically active material or electrodes manufactured from a catalytically active material are hereinbelow also referred to as “catalytically active electrode”. Non-catalytically active electrodes or baskets, which are not filled with a catalytically active material, may especially be employed in homogeneously catalyzed reactions.

The catalytically active material for coating the electrodes or the material from which the catalytically active electrode is manufactured or the catalytically active material introduced into the basket may be any catalytically active material known to those skilled in the art that may be utilized for the reactions to be investigated. Due to the interchangeability of the electrodes manufactured as baskets the apparatus according to the invention makes it possible to easily investigate different catalytically active materials by exchanging the electrodes configured as baskets in each case.

Reactions that may be investigated with the apparatus according to the invention include for example liquid phase reactions, gas phase reactions or reactions in the supercritical phase. The reactions may be reactions in the lower temperature range, i.e. reactions performed at temperatures in the range from −40° C. to 150° C. or else high-temperature reactions, i.e. reactions performed at temperatures in the range from 150° C. to 650° C. Reactions in the lower temperature range are especially performed in the liquid phase. High-temperature reactions are especially gas reactions, reactions that are performed in supercritical media or reactions using salt melts as electrolyte. Suitable salt melts include for example carbonate melts such as are used in molten carbonate fuel cells. It is alternatively possible to employ ceramic solid electrolytes for high-temperature reactions.

Especially for the investigation of high-temperature reactions it is necessary for all employed materials for the apparatus to be stable towards the temperatures at which the reaction is performed.

The container having a stirrer employed for the apparatus according to the invention may be for example a batch reactor, a semi-batch reactor or a continuous stirred tank reactor.

To prevent formation of an uncontrolled electric field and rule out risks to operators, the reactor vessel is internally lined with an electrically insulating coating or is manufactured from an electrically insulating material. This prevents the container itself from transmitting electrical current. This additionally ensures that the electric field in the reactor is established between the positive electrode and the negative electrode introduced into the reactor vessel.

Suitable materials for the electrically insulating coating include for example polymers such as polytetrafluoroethylene, polyamides or polyolefins provided the apparatus is used for reactions performed below the melting temperature in the case of thermoplastic polymers or the decomposition temperature in the case of thermosetting polymers. Especially for the investigation of high-temperature reactions it is preferable to manufacture the electrically insulating coating from ceramic or glass.

Especially glass is also suitable as an alternative electrically insulating material for manufacture of the container.

If reactions performed at positive pressure are to be investigated it is further necessary to manufacture the reactor vessel from a pressure-resistant material. Suitable materials for manufacture of the reactor include for example metals such as stainless steel, nickel-based alloys, titanium or fiber composite materials. If the material from which the reactor is manufactured is electrically conductive, in particular a metal or a carbon fiber-reinforced plastic, it is necessary to provide the interior thereof with an electrically insulating coating.

In addition to the interior of the reactor vessel the stirrer shaft is also provided with an electrically insulating coating or manufactured from an electrically insulating material for reasons of operator safety. However, if appropriately configured (for example ceramic bearing instead of steel ball bearing) a conventional magnetic stirrer drive is also possible since it effects torque transfer contactlessly. For a defined electric field between the negative electrode and the positive electrode in the case of stationary electrodes, especially when these are arranged perpendicularly to a central shaft through the reactor or radially encompass the central shaft of the reactor, it is further preferable when the stirrer comprises stirrer blades manufactured from an electrically non-conductive material or coated with an electrically non-conductive material.

Suitable materials for producing the stirrer shaft and the stirrer blades, provided these are manufactured from an electrically non-conductive material, or materials for coating the stirrer shaft and the stirrer blades include substantially the same materials that are also employable for coating or manufacturing the reactor vessel. Only the use of glass as a material for the stirrer shaft is not preferred.

The reaction vessel may have a lid or may also be operated without a lid. However, if gases are formed during the reaction or gases are employed as reactants it is preferable to provide a lid even if the reaction is performed at ambient pressure. However, if reactions performed at negative pressure or positive pressure (in each case relative to atmospheric pressure) are to be investigated it is necessary to seal the reaction vessel with a lid to be able to generate the desired pressure. However, it is particularly preferable to seal the reaction vessel with a lid irrespective of the pressure at which the reactions to be investigated are performed.

The use of a lid has the advantage that for example holders for the electrodes configured as a basket can be attached to the lid so that the electrodes configured as a basket can be easily exchanged when the lid is opened. If the electrodes configured as a basket are secured to holders on the lid these are further provided with electrical connections for the electrodes. These are fed through the lid into the interior of the reaction vessel so that the electrodes can be connected to the connections.

If no lid is provided it is preferable to provide holders to which the electrodes may be secured on the reaction vessel.

The use of holders allows rapid and easy exchange of the electrodes. It is particularly preferable when the holders comprise quick-release couplings to which the electrodes are secured.

In order to allow easy and rapid exchange of the electrodes and to prevent the electrical contacting of the electrodes from being forgotten it is further advantageous when the electrical contacting is also effected via the holders. To this end it is possible for example to provide an electrical conductor in at least one holder and to configure the holder such that the electrical conductor accommodated in the holder is contacted with the electrode secured in the holder. To prevent operators receiving an electric shock when touching the holder or causing a short upon accidentally contacting the holder it is further preferable when the electrical conductor extends inside the holder and is electrically insulated.

In addition to contacting of the electrodes via the holder it is alternatively also possible to provide the electrodes with electrical contacts which are fed outwards through the container wall or through the lid. In this case it is necessary for the feedthroughs for the electrical contacts to have an electrically insulated configuration, for example by introducing a sleeve made of an electrically insulating material into an opening through which the electrical contact is fed.

Since especially in the case of a centrally arranged stirrer an annular flow may be formed in the container with the result that the commixing of the components in the reaction mixture is impaired or even virtually completely ceases it is preferable to arrange baffles in the reactor vessel. The baffles interrupt the flow of the liquid, thus forming turbulences which improve commixing of the individual components in the reaction mixture.

If baffles are provided it is possible to make these electrically insulating. However, if stationary electrodes are provided it is alternatively also possible to configure the baffles as electrodes. In this case electrodes configured as baskets are employed as baffles in the container. To sufficiently disrupt the flow the baskets are preferably filled with turbulence promoters, especially with random packings. The turbulence promoters may also contain a catalytically active material and this is preferable especially when the reactions to be investigated are also heterogeneously catalyzed.

Reactions that may be investigated with the apparatus according to the invention include for example the conversion of carbon dioxide in the supercritical state into products for intermediate energy storage such as oxalic acid, formic acid or formaldehyde. However, in addition to these reactions the apparatus according to the invention may also be used for investigating any other reactions that are electrocatalytically activated or promoted.

In order to also allow optical investigation of the reaction occurring in the apparatus it is possible to provide the reactor vessel with at least one sightglass. It is also possible to provide a temperature control unit to heat or to cool the apparatus for investigating reactions. Especially when investigating exothermic reactions it may be necessary to dissipate the reaction heat formed during the reaction. Correspondingly, the investigation of endothermic reactions generally necessitates the supply of heat. Irrespective of whether an exothermic reaction or an endothermic reaction is investigated it may further be necessary to supply heat, at least in the beginning, in order to initiate the reaction. The temperature control unit may be any desired temperature control unit known to those skilled in the art. It is thus possible for example to provide pipe conduits in the reactor that are traversed by a temperature control medium, for example cooling water or heating steam or else a liquid temperature control medium such as a thermal oil. In addition to pipe conduits in the reactor it is also possible to apply pipe conduits to the outside of the reactor or to provide a double shell that is traversed by the temperature control medium.

Especially if it is necessary to supply large amounts of heat, or if high-temperature reactions are to be investigated, it is advantageous to provide electrical heating or to supply heat through combustion of a fuel. In this case the heating means is preferably outside the reaction vessel so that the heat is supplied via the wall of the reaction vessel.

Embodiments of the invention are depicted in the figures and are more particularly elucidated in the description which follows.

In the figures:

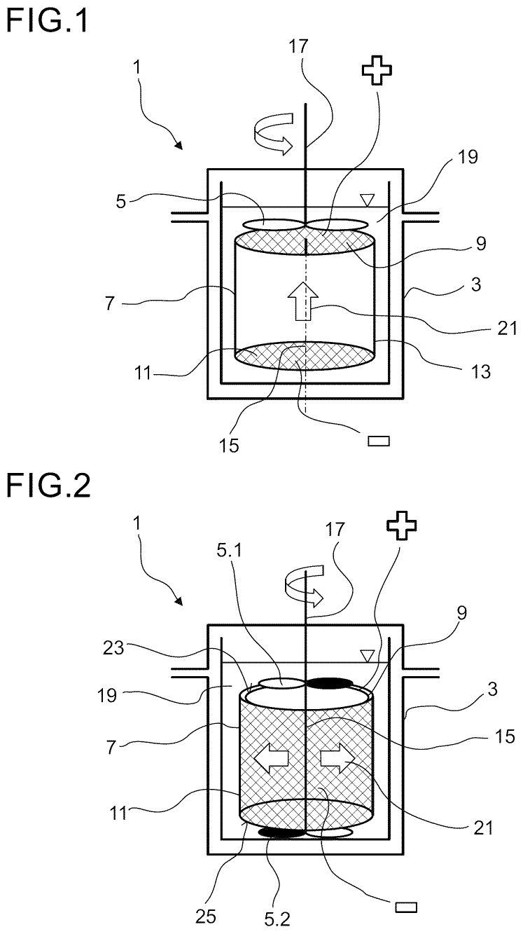

FIG. 1 shows a schematic representation of an inventive apparatus with electrodes oriented perpendicularly to the central shaft of the reaction vessel in a first embodiment,

FIG. 2 shows a schematic representation of an inventive apparatus with electrodes oriented radially to the central shaft of the reaction vessel in a first embodiment,

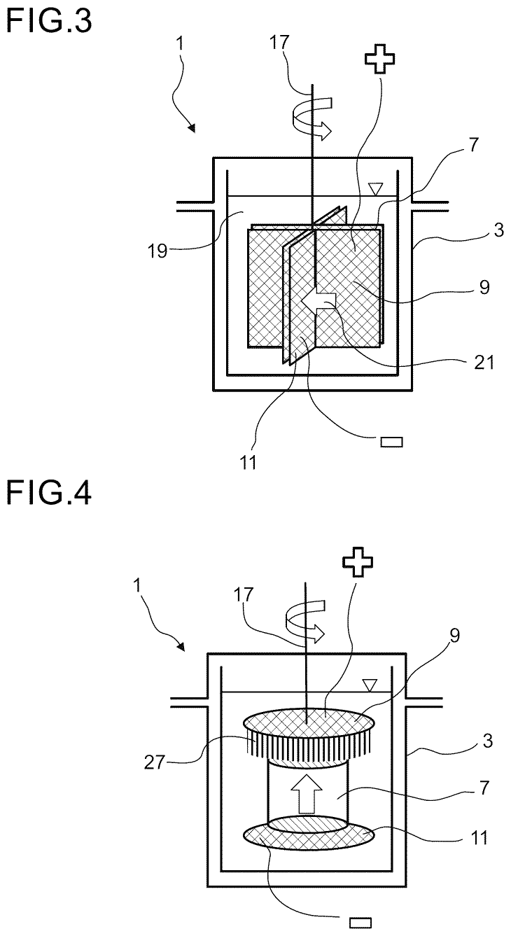

FIG. 3 shows a schematic representation of an inventive apparatus with electrodes configured as stirrer blades in a first embodiment,

FIG. 4 shows a schematic representation with electrodes oriented perpendicularly to a stirrer shaft, wherein an electrode is connected to the stirrer shaft, in a first embodiment,

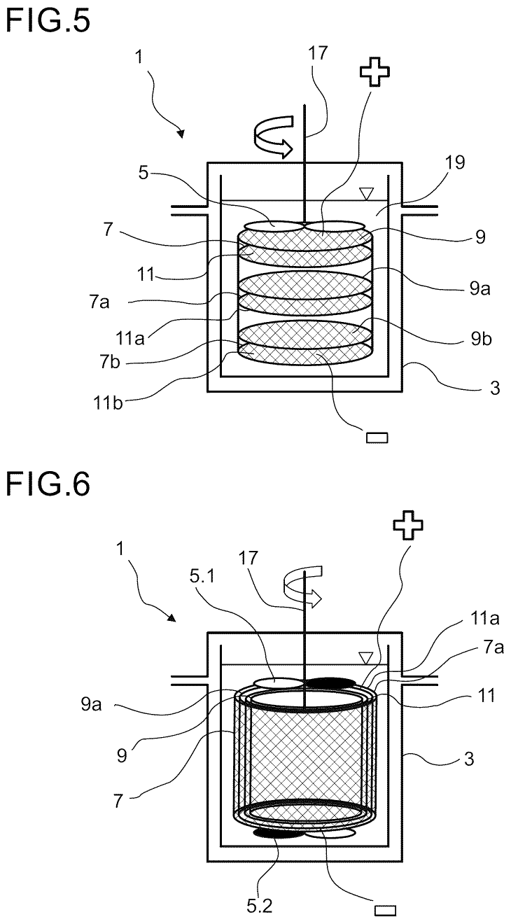

FIG. 5 shows a schematic representation of an inventive apparatus with electrodes oriented perpendicularly to the central shaft of the reaction vessel in a second embodiment,

FIG. 6 shows a schematic representation of an inventive apparatus with electrodes oriented radially to the central shaft of the reaction vessel in a second embodiment,

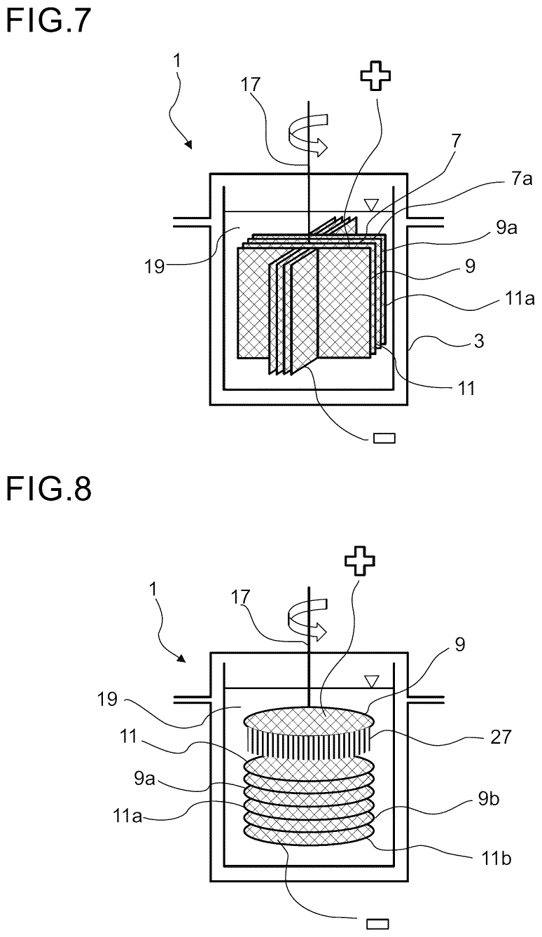

FIG. 7 shows a schematic representation of an inventive apparatus with electrodes configured as stirrer blades in a second embodiment,

FIG. 8 shows a schematic representation with electrodes oriented perpendicularly to a stirrer shaft, wherein an electrode is connected to the stirrer shaft, in a second embodiment,

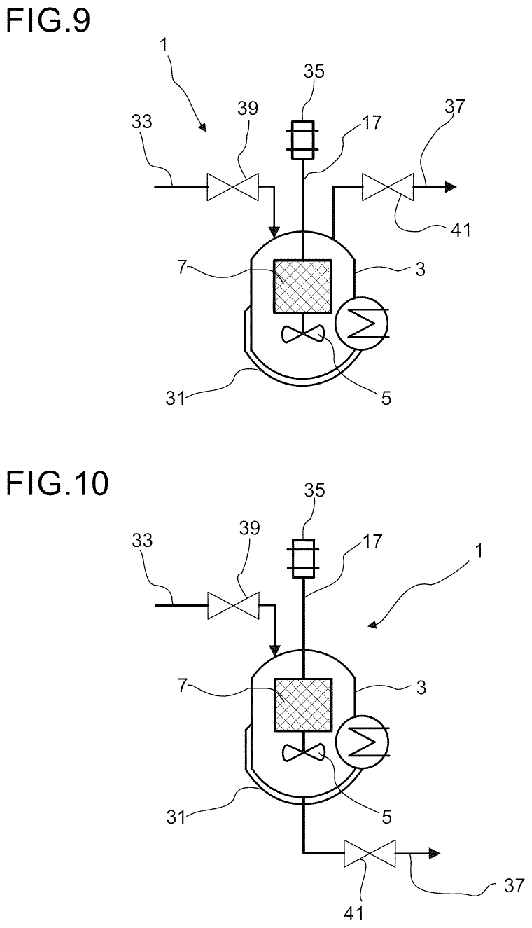

FIG. 9 shows a schematic representation of an apparatus for investigating reactions configured as a stirred tank,

FIG. 10 shows a schematic representation of an apparatus for investigating reactions configured as a stirred tank in a second embodiment,

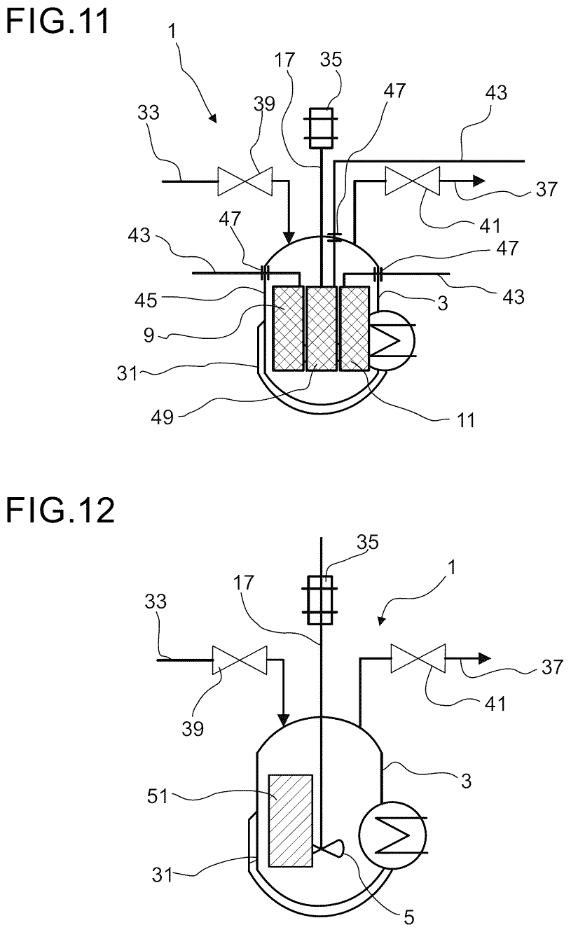

FIG. 11 shows a schematic representation of an apparatus for investigating reactions configured as a stirred tank comprising an anode, a cathode and a reference electrode,

FIG. 12 shows a schematic representation of an apparatus for investigating reactions configured as a stirred tank comprising a sightglass.

FIG. 1 shows a schematic representation of an inventive apparatus with electrodes oriented perpendicularly to the central shaft of the reaction vessel in a first embodiment.

An apparatus 1 for investigating electrocatalytic reactions comprises a container 3 having a stirrer 5. Electrodes 9, 11 configured as a basket 7 are accommodated in the container 3. To this end a positive electrode 9 and a negative electrode 11 are joined to one another via non-electrically conductive elements 13 to form the basket 7. The electrodes 9, 11 are oriented perpendicularly to a central shaft 15 of the container 3 in the embodiment shown in FIG. 1. Since the stirrer 5 is here likewise positioned centrally in the container 3, the stirrer shaft 17 forms a portion of the central shaft 15. To obtain uniform contact of a liquid reaction mixture 19 present in the reactor with at least one of the electrodes 9, 11 the electrodes 9, 11 are preferably manufactured such that the liquid can flow through the electrodes 9, 11. The flow in the reaction mixture 19 is produced by rotation of the stirrer 5. It is preferable to employ a stirrer which produces an axial flow, wherein this may be oriented either from bottom to top as shown here with arrow 21 or in the opposite direction from top to bottom. The direction of flow produced depends on the type and orientation of the stirrer and the direction of rotation thereof. Suitable stirrers include any axially conveying stirrers, for example inclined blade stirrers or propeller stirrers.

The non-electrically conductive elements 13 which join the negative electrode 11 and the positive electrode 9 to one another may be rods for example. It is alternatively also possible to use a cylindrical sleeve to join the electrodes 9, 11 to one another to form the basket. If a cylindrical sleeve is used this may be permeable to the reaction medium, for example in the form of a wire mesh or as a sleeve with openings formed therein. It is alternatively also possible to use a cylindrical sleeve that is not permeable to the reaction medium to join the electrodes 9, 11. In this case the stirrer produces a loop flow which causes the reaction medium to flow through the interior of the basket, over the edge of the cylindrical sleeve and around the outside of the cylindrical sleeve. The reaction medium then also flows through the electrodes which form the end faces of the basket configured as a cylinder.

If a heterogeneous solid catalyst is additionally to be employed this is preferably introduced into the basket. To this end the cylinder sleeve is either solid or alternatively configured in the form of a braid or weave, wherein the openings in the braid or weave must be smaller than the catalyst particles to prevent these from being washed out of the basket.

As an alternative to a weave or braid it is also possible to connect the electrodes 9, 11 with rods, wherein here too the distance must be selected such that no catalyst particles can be washed out of the basket.

In addition to the use of catalyst particles, for example a granulate comprising the catalytically active material or random packings comprising the catalytically active material, it is also possible to provide a structured packing comprising the catalytically active material. In this case the electrodes 9, 11 at the top and bottom may be joined to the structured packing, so that the basket is formed from the electrodes and the structured packing.

Even if the reaction is homogeneously catalyzed or no further catalyst is required it is possible to fill the basket formed by the electrodes with a particulate material, for example a granulate or random packings, or to provide a structured packing positioned between the electrodes 9, 11. In this case the particulate material or the structured packing promotes the commixing of the components of the reaction mixture.

In addition to the large distance between the electrodes as shown in FIG. 1, the positive electrode 9 and the negative electrode 11 may also be positioned much closer to one another. It must merely be ensured that the positive electrode 9 and the negative electrode 11 do not touch. In the case of a very small distance a solid electrolyte may to this end be accommodated between the electrodes for example. The solid electrolyte may also be in the form of a membrane for example. If at a small distance between the positive electrode 9 and the negative electrode 11 no solid electrolyte or else no separating membrane is to be accommodated, spacers, for example short rods or discs made of an electrically insulating material, may be used to ensure that the electrodes do not contact one another even in operation of the apparatus due to deformations resulting from the applied flow.

FIG. 2 shows a schematic representation of an inventive apparatus with electrodes oriented radially to the central shaft of the reaction vessel in a first embodiment.

In contrast to the embodiment shown in FIG. 1, in the embodiment shown in FIG. 2 the electrodes 9, 11 are arranged radially around the central shaft 15 of the container 3. To ensure uniform flow through the electrodes 9, 11, the stirrer shaft 17 is also on the central shaft 15 of the container 3.

The basket formed by the positive electrode 9 and the negative electrode 11 is in the shape of a cylindrical sleeve, wherein the thickness of the cylindrical sleeve corresponds to the distance between the electrodes 9, 11 plus the thickness of the electrodes 9, 11.

The distance between the positive electrode 9 and the negative electrode 11 may be ensured as described above for the electrodes 9, 11 arranged perpendicularly to the central shaft 15, for example by introducing a solid electrolyte or a separating membrane or else via suitable spacers.

Alternatively, the distance between the positive electrode 9 and the negative electrode 11 may be selected to be large enough for particles, for example a granulate or random packings or else a structured packing, to be introduced between the electrodes. The particles may, as described above, be inert and serve only to promote commixing of the components of the reaction mixture or alternatively may comprise a catalytically active material if a heterogeneous catalyst is to be employed in addition to the application of the electric field.

To ensure uniform flow through the electrodes 9, 11 it is necessary to produce a radial flow in the container 3. This is shown schematically with arrows 21.

The radial flow may be produced for example using a radially conveying stirrer, for example a disc stirrer. It is alternatively also possible, as shown here, to employ respective axially conveying stirrers 5.1, 5.2 above the upper edge 23 of the basket 7 and below the lower edge 25 of the basket 7, wherein the conveying direction of the axially conveying stirrers 5.1, 5.2 is opposed and each of the stirrers 5.1, 5.2 produces a flow into the interior of the basket 7. To this end the stirrers 5.1, 5.2 either rotate in opposite directions or, preferably, have the same direction of rotation and are mounted on a common stirrer shaft 17 but have oppositely oriented stirrer blades.

FIG. 3 shows a schematic representation of an inventive apparatus with electrodes configured as stirrer blades in a first embodiment.

In contrast to the embodiments shown in FIGS. 1 and 2 in the embodiment shown in FIG. 3 the basket 7 formed by the electrodes 9, 11 is accommodated in the container 3 in a dynamic rather than stationary fashion.

To this end the electrodes 9, 11 forming the basket 7 are joined to the stirrer shaft 17, so that the electrodes 9, 11 forming the basket 7 simultaneously function as stirrer blades. The arrangement shown here where an edge of the baskets 7 runs parallel to the stirrer shaft 17 produces a radial flow as shown schematically with the arrow 21.

To prevent establishment of a stationary flow rotating at the same speed as the electrodes 9, 11 it is preferable when baffles are positioned in the container 3. This makes it possible to ensure that liquid transfer is effected on the surfaces of the electrodes and the reaction mixture preferably flows through the baskets 7 formed by the electrodes 9, 11.

As also described above in relation to the stationary baskets the present baskets too may comprise particles such as a granulate or random packings or else a structured packing, wherein these either serve to improve commixing or comprise a catalytically active material. A further alternative for arranging the electrodes is shown in FIG. 4. Here, the positive electrode 9 is joined to the stirrer shaft 17 so that the latter rotates during operation and the negative electrode 11 is accommodated in the container 3 in a stationary fashion. In this case the basket 7 comprises only the stationary, presently negative, electrode 11.

To produce a flow in the container 3, the stirrer shaft 17 has a radial rotor 27 attached to it as the stirrer. The radial rotor 27 produces a flow, by means of which the liquid reaction mixture 19 flows into the basket 7 and, as a result of the radial rotor, over the surface of the rotating positive electrode 9.

It is particularly preferable in the embodiment shown in FIG. 4 when the stirrer shaft 17 is hollow and the reaction mixture can flow into the stirrer shaft 17 and openings in the stirrer shaft 17 are arranged in the region of the electrode 9 mounted on the stirrer shaft 17 so that the reaction mixture is passed out of the stirrer shaft 17 through the openings and over the electrode 9. Due to the outflow of the reaction mixture from the stirrer shaft a negative pressure is formed at the end of the stirrer shaft, thus causing reaction mixture to be aspirated into the stirrer shaft. This may be promoted by the flow produced by the radial rotor 27.

Here too, the basket 7 joined to the stationary negative electrode 11 may be filled with particles or a structured packing, each of which optionally contain a catalytically active material.

The embodiments shown in FIGS. 5 to 8 differ from the embodiments shown in FIGS. 1 to 4 in that they provide not only one positive electrode 9 and one negative electrode 11 in each case but rather a multiplicity of positive and negative electrodes in each case.

FIG. 5 shows a schematic representation of an inventive apparatus with electrodes oriented perpendicularly to the central shaft of the reaction vessel in a second embodiment. Here, in contrast to the embodiment shown in FIG. 1, a plurality of baskets 7, 7a, 7b are accommodated in the container 3. Each basket comprises a positive electrode 9, 9a, 9b and a negative electrode 11, 11a, 11b. The positive electrodes 9, 9a, 9b and the negative electrodes 11, 11a, 11b are in a respectively alternating arrangement.

The individual baskets preferably have the same construction as described above for FIG. 1.

FIG. 6 shows a schematic representation of an inventive apparatus with electrodes oriented radially to the central shaft of the reaction vessel in a second embodiment.

Here, in contrast to the embodiment as shown in FIG. 2, a multiplicity of electrodes is arranged concentrically around the central shaft 15 of the container 3.

Similarly to the embodiment shown in FIG. 5, this embodiment also comprises a respectively alternating arrangement of a positive electrode 9, 9a and a negative electrode 11, 11a, wherein each basket 7, 7a is formed by one positive electrode 9, 9a and one negative electrode 11, 11a.

FIG. 7 shows a schematic representation of an inventive apparatus with electrodes configured as stirrer blades in a second embodiment which differs from the embodiment shown in FIG. 3 in that the stirrer blades each comprise more than two electrodes.

If the electrodes in each case form stirrer blades and more than only two electrodes are provided per stirrer blade these are likewise provided in an alternating arrangement as described above for the stationary electrodes, wherein each basket 7, 7a is formed by one positive electrode 9, 9a and one negative electrode 11, 11a.

The embodiment shown in FIG. 8 also differs from that shown in FIG. 4 in that a multiplicity of electrodes is provided. Here too, the electrodes are in an alternating arrangement, wherein all positive electrodes 9, 9a, 9b may be joined to the stirrer shaft 17 and all negative electrodes 11, 11a, 11b may be stationary or vice versa.

It is alternatively also possible for only one electrode to be joined to the stirrer shaft and for all others to be stationary in the container 3, wherein the stationary electrodes 9a, 9b, 11, 11a, 11b may form one or more baskets. If the electrodes form a plurality of baskets it is preferable here too for each basket to be formed by one positive electrode 9a, 9b and one negative electrode 11, 11a, 11b.

In the case of only one rotating electrode 9 the radial rotor 27 is arranged below the rotating electrode 9 as shown here. In the case of two or more rotating electrodes it is preferable when a radial rotor is arranged below or above each rotating electrode.

In addition to an embodiment as shown in FIGS. 5 to 8 and where each basket 7, 7a, 7b is formed by one positive electrode and one negative electrode it is also possible for two or more or all electrodes 9, 9a, 9b, 11, 11a, 11b to be arranged in a common basket. Irrespective of whether the multiplicity of electrodes form only one basket or in each case one positive electrode and one negative electrode form one basket, the baskets may comprise—as described hereinabove—particles or a structured packing which optionally comprises catalytically active material. When a plurality of electrodes are present in one basket it is preferable when the number of positive electrodes and negative electrodes in a basket is equal.

Furthermore, in all variants the distances between the positive electrodes 9, 9a, 9b and the negative electrodes 11, 11a, 11b may in each case be identical or the distances between the respective one positive electrode 9, 9a, 9b and negative electrode 11, 11a, 11b forming one basket 7, 7a, 7b are identical and the distance between the baskets 7, 7a, 7b is likewise identical in each case but differs from the distance between the electrodes that each form a basket.

Alternatively to the arrangements shown in FIGS. 1 to 8 comprising the positive electrode 9, 9a, 9b and the negative electrode 11, 11a, 11b the electrodes may also be connected in the opposite way so that the positive electrode shown here is the negative electrode and the negative electrode shown here is the positive electrode.

FIGS. 9 and 10 show two alternative embodiments of an apparatus for investigating reactions configured as a stirred tank.

The apparatus 1 for investigating electrocatalytic reactions comprises a container 3 having a stirrer 5 which is in the form of a stirred tank. Furthermore, the electrodes forming the basket 7 are accommodated in the container 3, wherein the arrangement of the stirrer 5 and the basket 7 may correspond to one of those shown in FIGS. 1 to 8.

In order additionally to be able to supply heat, for example as activation energy or in the case of an endothermic reaction, or to be able to dissipate heat especially in the case of an exothermic reaction it is preferable when the container 3 is temperature-controllable, for example through the provision of a double shell 31 traversable by a temperature control medium. Alternatively to a double shell 31 it is also possible to apply pipe coils traversed by the temperature control medium to the container 3. If heat is to be supplied, electrical heating or heating with a burner may also be provided for in addition to temperature control with a temperature control medium inter alia according to whether a high-temperature reaction or a reaction at relatively low temperature is to be performed in the apparatus 1.

To allow components for the reaction to be supplied, the container comprises at least one inflow 33. It is possible to provide only one inflow 33, by which the components are supplied in admixture or consecutively, or a separate inflow 33 for each component.

In order to drive the rotor 5 with the rotor shaft 17 or, if rotating baskets 7 are provided, the baskets 7, the rotor shaft 17 is joined to a motor 35.

The reaction mixture formed in the container 3 is withdrawn from the container 3 via an outflow 37. This may be arranged at the lid of the container 3 as shown in FIG. 9 or at the bottom of the container 3 as shown in FIG. 10.

The arrangement of the outflow 37 at the lid of the container 3 is preferable especially when a gaseous reaction product is formed during the reaction. In this case an outflow may additionally be provided at the bottom of the container to allow withdrawal of liquid components from the container 3. Alternatively to an outflow for liquid components at the bottom it is also possible to provide an immersion tube which is passed through the lid into the container 3 and to withdraw the liquid components through the immersion tube.

The apparatus 1 configured as a stirred tank may be operated in continuous mode, in semi-batch mode or in batch mode. In continuous mode components are continuously supplied via the inflow 33 and are withdrawn via the outflow 37. In semi-batch mode at least one component is supplied continuously and at least one component is initially charged. The product may be withdrawn continuously or alternatively after a predetermined time. Batch mode comprises initially supplying all components, performing the reaction and then after completion of the reaction withdrawing the reaction product.

To make it possible to control the addition of the components it is preferable to provide in the inflow 33 a valve 39 which is opened whenever a component is to be supplied. A valve 41 is correspondingly provided in the outflow 37 to control withdrawal of the reaction product. In the case of continuous withdrawal, the valve 41 is used to control reactor pressure for example and the valve 39 is used to control inflow. In batch mode valve 41 is closed for as long as the reaction is performed and after completion of the reaction the valve 41 is opened to withdraw the reaction mixture from the container 3. Decreasing or increasing pressure may optionally be re-adjusted via the valve 39.

FIG. 11 shows a schematic representation of an apparatus for investigating reactions configured as a stirred tank comprising an anode, a cathode and a reference electrode.

The construction of the apparatus 1 shown in FIG. 11 substantially corresponds to that shown in FIG. 9. The connection of the electrodes 9, 11 is shown in more detail here. To this end the electrodes 9, 11 are each connected to an electrical conductor 43. The electrical conductors 43 are fed through the wall 45 of the container 3, wherein the feedthroughs 47 for the electrical conductors 43 are electrically insulated to prevent conduction of current through the container wall and potentially an undesired short. This also prevents operators coming into contact with the container from receiving an electric shock.

The embodiment shown in FIG. 11 additionally provides a reference electrode 49 which is likewise connected to an electrical conductor 43.

The reference electrode 49 makes it possible to measure the electrical potential of half-cells relative to a defined reference potential. Measurements of the potential difference between the positive electrode and the negative electrode do not yet give any indication of the actual half-cell potential. The reference electrode 39 is typically arranged plane-parallel or else concentrically to the positive or to the negative electrode, for example between the two electrodes.

To allow observation of the reaction in the container, a sightglass 51 may be configured in the container wall. The sightglass may be made of any optically transparent material, for example a transparent plastic or glass. The choice of material for the sightglass 51 is especially dependent on the reactions to be investigated and the pressure and the temperature at which the reactions are performed. The material must have sufficient mechanical stability to withstand the pressure and be sufficiently heat-resistant to avoid damage at the temperatures occurring in the reactor. In addition, the material for the sightglass 51 must also be inert towards the components in the reaction mixture in the container 3. It is particularly preferable to use glass as the material for the sightglass 51.

1. An apparatus for investigating electrocatalytic reactions comprising a container having a stirrer, wherein the container is internally lined with an electrically insulating coating or is manufactured from an electrically insulating material and the stirrer has at least one stirrer shaft provided with an electrically insulating coating or manufactured from an electrically insulating material and electrodes configured as exchangeable baskets are positioned in the container.

2. The apparatus as claimed in claim 1, wherein the electrodes are macroporous or microporous.

3. The apparatus as claimed in claim 1, wherein in each case a positive electrode and a negative electrode are joined to form a basket via electrically non-conductive joins.

4. The apparatus as claimed in claim 1, wherein each basket is filled with a catalytically active material.

5. The apparatus as claimed in claim 1, wherein the baskets are each configured as double-walled electrodes, wherein a separating membrane is accommodated between the electrodes.

6. The apparatus as claimed in claim 1, wherein the electrodes are arranged perpendicularly to a central shaft through the container or radially encompass the central shaft of the container.

7. The apparatus as claimed in claim 1, wherein the stirrer has stirrer blades made of an electrically nonconductive material.

8. The apparatus as claimed in claim 1, wherein the electrodes configured as baskets are joined to the stirrer shaft.

9. The apparatus as claimed in claim 8, wherein the electrodes joined to the stirrer shaft are arranged perpendicularly to the stirrer shaft.

10. The apparatus as claimed in claim 9, wherein stirrer blades of a radial rotor are arranged between the electrodes arranged perpendicularly to the stirrer shaft.

11. The apparatus as claimed in claim 8, wherein the electrodes joined to the stirrer shaft function as stirrer blades.

12. The apparatus as claimed in claim 1, wherein baffles are arranged in the container.

13. The apparatus as claimed in claim 12, wherein the baffles are configured as electrodes.
